(19) United States
(12) Patent Application Publication
(10) Pub. No.: US 2003/0052155 A1
(43) Pub. Date: Mar. 20, 2003

(54) Universal ball attach manufacturing process

(75) Inventors: Raj N. Master, San Jose, CA (US); Cheon-Seng Chan, Singapore (SG); Ooi-Tong Ong, Singapore (SG)

Correspondence Address: MCDERMOTT, WILL & EMERY, 600 13th Street, N.W., Washington, DC, 20005-3096, US

(73) Assignee: Advanced Micro Devices, Inc.

(21) Appl. No.: 10/062,515

(22) Filed: Feb. 5, 2002

Related U.S. Application Data
(60) Provisional application No. 60/317,967, filed on Sep. 10, 2001.

(51) Int. Cl. B23K 31/02

(52) U.S. Cl. 228/123.1

(57) ABSTRACT

A universal attach manufacturing process employs a boat onto which solder balls or columns are loaded. A universal attach line has a number of attach station to accommodate different types of attach processes. Depending on the process and the desired configuration and form factor of the array of solder balls or columns, a template is selected that covers some of the holes in the universal boat, and exposes other holes. The solder balls or columns are held securely in the exposed holes, and a substrate is placed onto the solder balls. Once loaded with balls or columns, the universal boat is transported to only the appropriate attach stations in the universal attach line, where the different attach operations for a given attach process, such as high temperature ball attach, eutectic ball attach, or column attach, are performed.

### RELATED APPLICATIONS

This application contains subject matter related to the subject matter disclosed in copending U.S. Provisional Patent Application Serial No. 60/317,967, filed on Sep. 10, 2001 (our Docket No. 50432-513)

### FIELD OF THE INVENTION

The present invention relates to the field of semiconductor packaging and assembly, and more particularly, to processes for attaching solder balls or columns to a workpiece, such as a package.

### BACKGROUND OF THE INVENTION

In conventional semiconductor packaging, after the semiconductor die has been attached to a package and an underfill operation is performed, the assembled package is placed into a boat, with the die in the bottom of the boat, and the bottom surface of the package exposed. Solder balls are picked up from a reservoir by an array of vacuum tips. The solder balls are fluxed so that they will be held in place on the package surface. The solder balls are placed into contact with the package surface and the vacuum tips release the solder balls.

The boat with the packages having solder balls placed on them is now moved into a reflow oven where heating occurs to cause reflow and the solder balls to attach to the package surface. Following the reflow process, the package is extracted from the boat.

Although this process has found wide acceptance through the semiconductor industry, there are a number of problems with the process. One of these is that every time there is a change in the size of the solder ball array, with a different form factor, or in the configuration of the solder ball array, the configuration of the vacuum tips has to be changed. This is a complicated procedure, and both costly and time-consuming. Hence, it is difficult using the present process to accommodate changes in form factor and configuration.

Another concern is the loss of balls from the array. This loss can occur in different ways. For example, when the vacuum tips pick up the balls from the array, one or more of the vacuum tips may fail to pick up a solder ball from the reservoir. This is difficult to discern by visual inspection. Even after picking up the balls, one or more vacuum tips may drop a solder ball before the balls are placed onto the package. Once the solder balls are placed onto the package surface, the solder balls may still be lost from the array as the boat is moved into the reflow oven, typically on an assembly line. In other words, a solder ball may move from its location on the package surface as the package is moved, until the reflow process is performed. These problems create what is known as a missing ball defect. Typically, such missing ball defects are dealt with by simple rejection of the assembled package.

To minimize the movement of solder balls and missing ball defects once the solder balls are placed on the package surface, flux is employed on the solder balls. However, the tackier the flux is made, to reduce movement and ball loss to the greater extent, the more difficult it becomes to remove the flux after the reflow operation. The flux removal process normally employs physical handling of the package assembly, and there is often breakage of the parts during flux cleaning. The use of a “no-clean” flux helps to reduce breakage, but increases the amount of missing ball defects since no-clean flux is not very tacky.

There is therefore a need for a ball attach process that is universal in that it can be used in different types of attach processes, such as high temperature ball attach, eutectic ball attach, and column attach, that eliminates missing and misplaced balls, and makes possible a no-clean process.

### SUMMARY OF THE INVENTION

These and other needs are met by embodiments of the present invention which provide a universal ball attach manufacturing process for semiconductor packages, comprising the steps of loading at least one of solder balls and columns onto a boat, placing a substrate on the solder balls of columns, and reflowing to attach the solder balls or columns to the substrate.

The use of a boat to hold solder balls or columns allows a package to be placed on the solder balls, and reduces the chances of missing and misplaced balls. Since the balls are loaded onto a boat, a visual inspection can be easily made to make sure that all of the solder balls are present, thereby reducing the potential for missing balls. Also, by holding the balls and placing the package on the balls, rather than the balls on the package, the balls are held in place by the boat and the weight of the package on the balls as the boat is moved into the reflow oven. This helps to prevent movement of the balls and misplacement of the balls. Further, the use of no-clean flux is possible since a tackier flux, requiring cleaning, is not needed to hold the balls in place. Since a no-clean process can be used, damage to the assembled packages caused by cleaning is avoided.

The use of a boat also allows different attach processes to be practiced readily, by loading the boat into different attach stations specific for the different attach processes. Using different templates on the boat, as provided in certain embodiments of the invention, permits different configurations and form factors for the array of balls, and does away with the use of a vacuum tip array.

The earlier stated needs are also met by embodiments of the present invention which provide a universal attach method for a universal assembly line having attach stations for at least two different attach processes, the method comprising the steps of selecting a template having a first opening configuration, placing the template on a boat having a number M of holes, the template covering N holes and exposing P holes, such that M=N+P, and loading the boat with P solder balls or columns. Attach operations are performed at the attach stations for only of the different attach processes.

The foregoing and other features, aspects and advantages of the present invention will become more apparent from the following detailed description of the present invention when taken in conjunction with the accompanying drawings.

### BRIEF DESCRIPTION OF THE DRAWINGS

FIG. 1 is a top view of a boat for use in the method of the present invention.

FIGS. 2a and 2b are top views of the boat of FIG. 1, illustrating different exemplary templates on top of the boat.

FIG. 3 is a side view of the boat and a package assembly prior to placement of the package assembly on the solder balls held by the boat.

FIG. 4 is a side view of the boat and package assembly after placement of the package assembly on the solder balls held by the boat.

FIG. 5 is a block diagram of the universal attach line constructed in accordance with embodiments of the present invention.

FIG. 6 is a cross-sectional side view of a detail of a single hole in a boat constructed in accordance with embodiments of the present invention.

### DETAILED DESCRIPTION OF THE INVENTION

The present invention addresses problems related to missing and misplaced ball defects after ball attach processes are performed, damage caused by cleaning of flux, and the need to reconfigure vacuum tip configurations when a ball or column attach configuration and form factor is changed. The present invention solves these problems, in part, by loading solder balls or columns onto a boat, where they are securely held in place and a package is placed on them. Visual inspection is readily performed on the loaded boat to ensure that balls are not missing from the array. The holding of the balls on the boat, and the placement of the package on top of the balls or columns prevents movement of the balls or columns as the boat and package are moved into a reflow oven. Also, a no-clean process is available since a tacky flux is not required to hold the balls in place on a package. The use of a universal boat, with a large number of holes for receiving balls, permits the use of different templates to accommodate different configurations, form factors, and different types of attach processes, including high temperature ball attach, eutectic ball attach, and column attach. A universal attach line can therefore be created, and only those operations for a specific attach process are performed on the high temperature solder balls, the eutectic solder balls, or columns that are loaded on the boat. This flexibility in attach processing reduces manufacturing costs by reducing the number of redundant attach stations, such as a reflow oven and an extractor.

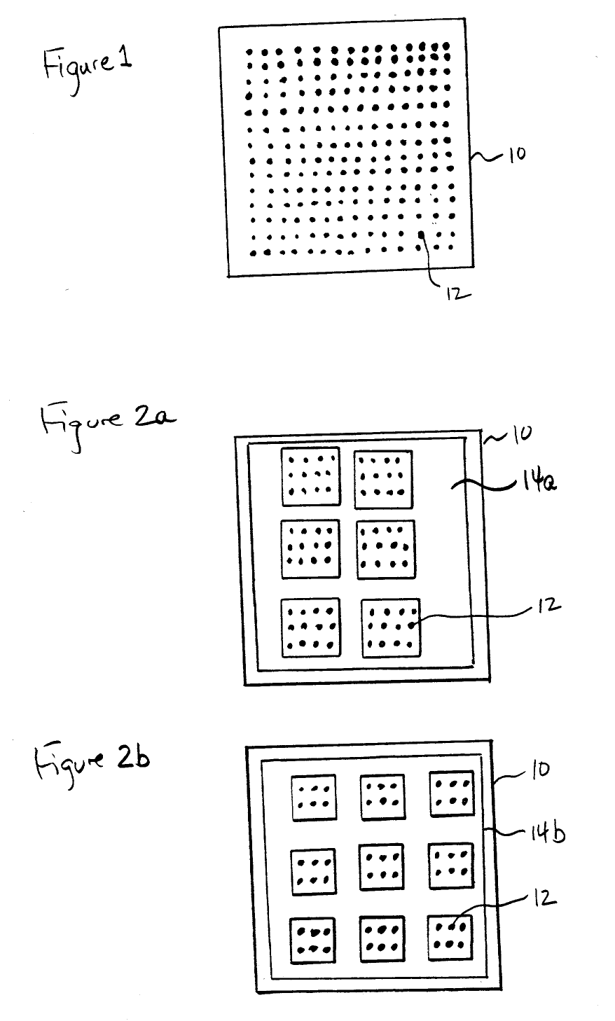

FIG. 1 depicts a top schematic view of an exemplary boat 10 for holding solder balls or columns to perform the methods of the present invention. The boat 10 has a large number of holes 12, or recesses, configured to hold a plurality of solder balls or columns in the individual holes 12. The number of holes 12 on the boat 10 is large enough to accommodate a plurality of packages so that ball attach or column attach on a plurality of packages can be performed simultaneously. In the following example, however, for ease of explanation and illustration, it is assumed that ball attach is being performed on only a single package.

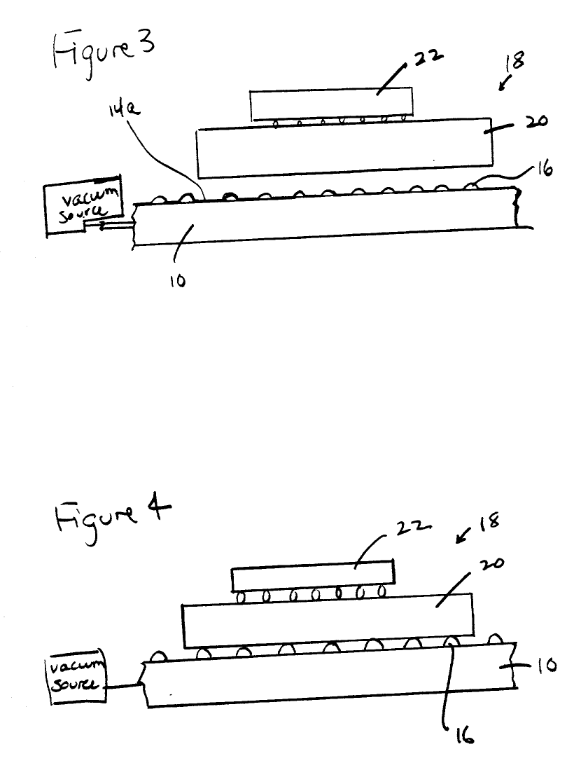

The boat 10 is made of graphite or similar material, in certain embodiments of the invention. As depicted in FIGS. 2a and 2b, a template 14a or 14b, is placed on the top surface of the boat 10. The templates 14a and 14b can be made of stainless steel, or other suitable material, for example. The templates 14a and 14b, cover a number of the holes 12, and expose the remaining holes. The templates 14a and 14b can have a large number of holes that register with holes 12, or a single opening that exposes an area of holes. The templates 14a and 14b provide fast and simple changing of the configuration of the ball array to accommodate different form factors, or desired configurations. The shapes of the different templates 14a and 14b are exemplary only, as any number of different configurations and form factors are possible. The large number of holes 12 in the boat 10 provide universality since they permit the use of many differently configured templates, as will be readily appreciated by one of ordinary skill in the art.

Loading of the boat 10 with solder balls or columns occurs after the selected template 14a or 14b is in place on the top surface of the boat 10. The template 14a or 14b is selected dependent upon the configuration of the desired attach array and the attach process that will be performed. For solder balls, the boat 10 has a large number of solder balls placed on its top surface to cover the boat 10, and the boat 10 is shaken to cause the balls within the opening of the selected template (e.g., template 14a) to seat within the exposed holes 12. The remaining balls fall back into the reservoir of solder balls. Vacuum may be applied through the holes 12 to more securely hold the solder balls in place on the boat 10.

FIG. 6 shows in more detail a cross-sectional side view of one of the holes 12 in the boat 10. Although a specific preferred embodiment will be described with respect to the configuration of the holes 12, it should be recognized that this described embodiment is exemplary only and that other configurations of the boat 10 and holes 12 are contemplated within the scope of the present invention.

The hole 12 comprises two main sections: a vacuum hole 50 and a countershank 52. The vacuum hole 50 has a vertical sidewall 54, and is generally circular in horizontal cross-section. The countershank 52 has an angled sidewall 56 that angles away from the vertical (i.e., opens outwardly) by an angle α. A solder ball 16 loaded onto the boat 10 seats within the countershank 52 and rests on the countershank wall 56.

The dimensions of the hole 12, including the angle α of the countershank wall 46, and the diameter of the vacuum hole (VH_{d}) have an effect on the extent of protrusion of the solder balls 16 above the hole 12 (i.e., above the top surface 58 of the boat 10). The ball protrusion (Bₚ) is a critical consideration in the design of the boat 10 in that balls 16 that do not protrude enough will not contact the package when the package is placed on the array of balls 16. This is due also to the inability to produce a perfectly flat package. The slight imperfections or warp in a package will cause solder balls 16 that sit too low in their holes 12 from contacting and attaching to the package during substrate placement and reflow. At the same time, however, a problem with ball quality can occur when the balls 16 protrude too far out of the holes 12. Such problems include the quality of the balls 16 themselves, including scratches on the surfaces of the balls 16.

To address these concerns, in certain preferred embodiments of the invention, the vacuum hole diameter is 0.7 mm, +0.15 mm and −0.10 mm; the angle α is 45°, to provide a ball protrusion of 0.085 mm+/−0.02 mm. These parameters are appropriate when the solder balls 16 have a diameter of about 30 mils. Other parameters may be used when greater or lesser amounts of protrusion are desired. In other embodiments of the invention, the angle α is between 25° and 60°.

Another consideration in determining the hole parameters is preventing the solder balls 16 from becoming stuck within the holes 12 by melting into a misshaped bump during reflow so that they do not lift out of the holes 12 during the extraction process. The parameters provided in the example above overcome this concern.

Either during or after the solder balls 16 are loaded into the holes 12, vacuum is applied through the vacuum holes 40 to further securely hold the solder balls 16 in place. Visual inspection is readily performed on the loaded boat 10 to ensure that balls 16 are not missing from the array. The holding of the balls 16 on the boat 10, and the placement of the package 20 on top of the balls or columns, prevents movement of the balls or columns as the boat 10 and package assembly 18 are moved into a reflow oven. Also, a no-clean process is available since a tacky flux is not required to hold the balls 16 in place on a package 20.

FIG. 3 depicts the boat 10 loaded with balls 16. A visual inspection can now be performed to ensure that all of the desired solder balls 16 are loaded on the boat 10. This helps to prevent missing ball defects. Depending on the particular attach process, a flux may now be applied, and a package assembly 18 placed on the tops of the solder balls 16, which protrude by a specified amount above the boat 10. The package assembly 18 typically comprises a package 20 to which a semiconductor integrated circuit die 22 has been attached previously.

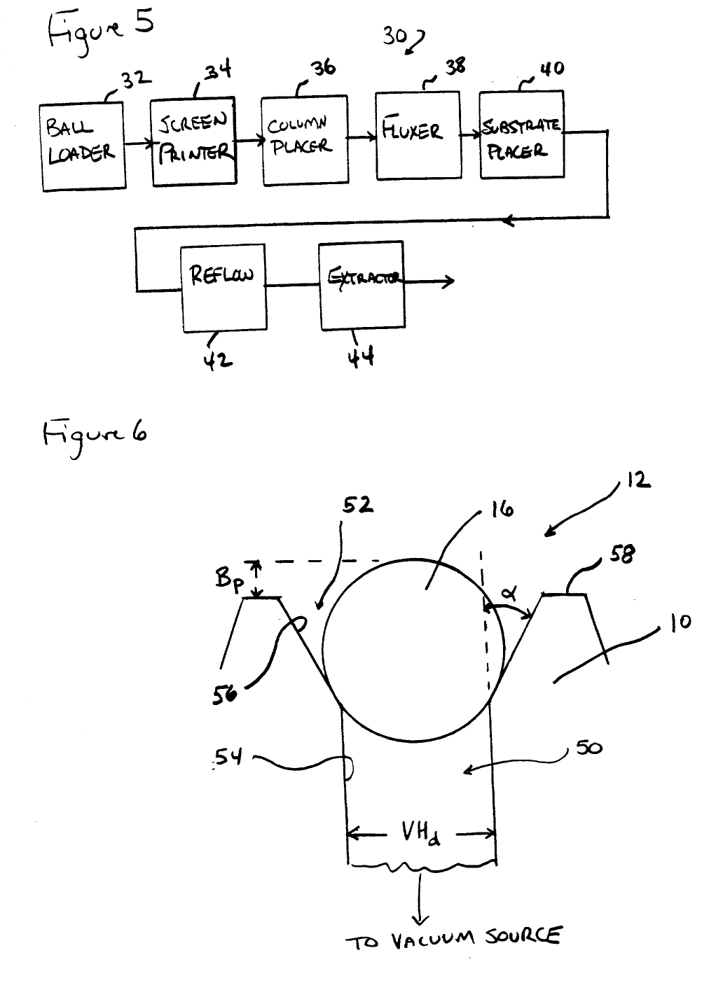

The package assembly 18 is carefully positioned over the boat 10 and the solder balls 16 and placed on top of the solder balls 16, by a substrate placer (not shown). The result of this operation is depicted in FIG. 4. At this point, the boat 10 is holding the solder balls 16 or columns firmly and the weight of the package assembly 18 aids in preventing movement of the solder balls 16. A second template (not shown) can be placed over the first template 14a and 14b, and serves to register and hold the package assembly 18 in place on the solder balls 16. The boat 10 and the package assembly 18 are transported to a reflow oven (not shown) where a reflow process occurs to attach the solder balls 16 or the columns to the package 20 of the package assembly. After the reflow process, the boat 10 and the package assembly are transported to an extractor (not shown) where the package assembly 18 with the now attached solder balls or columns is extracted from the boat 10.

A universal attach manufacturing line 30 is depicted in FIG. 5. The line 30 can handle a plurality of different attach processes, including high temperature ball attach, eutectic ball attach, and column attach. The use of a universal manufacturing line 30 provides rapid response to changes in desired attach processes, and employs common attach stations to avoid redundancy that would occur if the attach lines for different attach processes were all separate.

The line 30 comprises a ball loader station 32 in which a boat 10, as described earlier, is loaded with solder balls 16 in accordance with a selected template 14a or 14b. The ball loader station 32 is used to load either high temperature solder balls 16 or eutectic solder balls 16. The line 30 includes a screen printing station 34, which is used in a conventional manner during a high temperature solder ball attach operation.

A column placer station 36 places columns with interposers on the boat 10 and is used instead of the ball loader 30 during column attach processes. A fluxing station 38 is provided to apply flux, preferably no-clean flux, to the solder balls 16. The flux is normally employed in eutectic ball attach operations.

Stations 40, 42 and 44 are common to all of the attach operations. The package assembly 18 is placed onto the solder balls 16 or column in the substrate placer station 40. The boat 10 and the package assembly 18 are then transported to the relow oven 42, where the reflow operation is performed to attach the high temperature solder balls 16, eutectic solder balls 16 or columns to the package 20. The extractor station 44 removes the package assembly with the now attached solder balls or columns from the boat 10.

Hence, depending on the attach process that is to be performed, the boat 10 is processed at only some of the different attach stations 32-44 in the universal assembly line. For a high temperature solder ball attach process, the ball loader station 32, substrate placer station 40, reflow oven station 42 and extractor station 44 are employed. In a eutectic solder ball attach process, the ball loader station 32, the fluxing station 38, the substrate placer station 40, the reflow oven station 42, and the extractor station 44 are employed. For a column attach process, the column placer station 36, the substrate placer 40, the reflow oven 42, and the extractor station 44 are used.

The embodiments of the present invention provide a universal attach process that performs a number of different attach processes, and eliminates or minimizes missing or misplaced ball defects, through the use of a universal boat that accommodates different configurations and form factors of the attach array. Since the boat is loaded with the solder balls or columns, and the substrate (e.g., package assembly) is placed on top of the solder balls or columns, visual inspection for missing balls is readily performed, and movement of the balls is prevented. The universality of the boat, in conjunction with the use of different templates, allows for simple conversion to different array configurations without the need to reconfigure a vacuum tip arrangement, and the use of the boat in a number of different attach processes.

Although the present invention has been described and illustrated in detail, it is to be clearly understood that the same is by way of illustration and example only and is not to be taken by way of limitation, the scope of the present invention being limited only by the terms of the appended claims.

What is claimed is:

1. A universal ball attach manufacturing process for semiconductor packages, comprising the steps of:
loading at least one of solder balls and columns onto a boat;
placing a substrate on the solder balls or columns; and
reflowing to attach the solder balls or columns to the substrate.

2. The method of claim 1, wherein the boat includes a first plurality of holes configured to hold the solder balls or columns.

3. The method of claim 2, further comprising placing a first template on the boat, the first template having an opening that exposes a second plurality of holes that is less than the first plurality of holes.

4. The method of claim 3, further comprising placing a second template on the boat, the second template having an opening that exposes a third plurality of holes that is less than the first plurality of holes and at least some of which are different than the second plurality of holes.

5. The method of claim 1, wherein an assembly line comprises processing equipment for high temperature ball attach, eutectic ball attach and column attach.

6. The method of claim 5, wherein the assembly line comprises a ball loader station, a screen printer station, a column placer station, a fluxing station, a reflow oven station, and an extractor station.

7. The method of claim 6, further comprising performing high temperature ball attach by performing screen printing after the boat has been loaded with high temperature solder balls, followed by the steps of placing the substrate on the high temperature solder balls and reflowing to attach the high temperature solder balls.

8. The method of claim 6, further comprising performing eutectic ball attach by fluxing eutectic solder balls in the fluxing station after the boat has been loaded with eutectic solder balls, followed by the steps of placing the substrate on the eutectic solder balls and reflowing to attach the eutectic solder balls.

9. The method of claim 6, further comprising performing column attach by loading the boat into the column placer station, and loading columns with interposers into the boat, followed by fluxing the columns in the fluxing station, and the steps of placing the substrate on the columns and reflowing to attach the columns.

10. A universal attach method for a universal assembly line having attach stations for at least two different attach processes, the method comprising the steps of:
selecting a template having a first opening configuration;
placing the template on a boat having a number M of holes, the template covering N holes and exposing P holes, such that M=N+P;
loading the boat with P solder balls or columns; and
performing attach operations at the attach stations for only of the different attach processes.

11. The method of claim 10, wherein the different attach processes include high temperature ball attach, eutectic ball attach, and column attach.

12. The method of claim 11, wherein the attach stations for all of the attach processes include a substrate placer station, a reflow oven station, and an extractor station.

13. The method of claim 12, wherein the attach stations for the high temperature ball attach also include a ball loader station and a screen printer station.

14. The method of claim 12, wherein the attach stations for the eutectic ball attach also includes a ball loader station and a fluxing station.

15. The method of claim 12, wherein the attach station for the column attach also include a column placer station and a fluxing station.

16. The method of claim 10, wherein the template is selected based on a desired form factor and configuration of the balls or columns.
